(19) United States
(12) Patent Application Publication
(10) Pub. No.: US 2010/0274726 A1
(43) Pub. Date: Oct. 28, 2010

(54) SYSTEM AND METHOD OF CONTACTLESS AUTHORIZATION OF A PAYMENT

(75) Inventors: Miroslav Florek, Bratislava (SK); Michal Masaryk, Bratislava (SK)

Correspondence Address: WOODCOCK WASHBURN LLP, CIRA CENTRE, 12TH FLOOR, 2929 ARCH STREET, PHILADELPHIA, PA, 19104-2891, US

(73) Assignee: Logomotion, S.R.O, Piestany (SK)

(21) Appl. No.: 12/747,114

(22) PCT Filed: Sep. 18, 2009
(86) PCT No.: PCT/IB2009/054097

§ 371 Date: Jun. 9, 2010

(30) Foreign Application Priority Data
Sep. 19, 2008 (SK) PP 5085-2008

(51) Int. Cl. G06Q 20/00; H04L 9/32; G06F 21/00

(52) U.S. Cl. 705/72; 705/21; 705/16; 726/18

(57) ABSTRACT

The system consists of a POS terminal (6), a secure element (2), a mobile communication device (1) with a display and a keyboard, such as a mobile phone. The mobile communication device (1) is equipped with a removable memory card (3), in which there are at least two physically separate secure elements (2) located. The mobile communication device (1) is connected to the POS terminal (6) through a contactless transmission channel (5) and at least one secure element (2) on the removable memory card (3) contains a payment card unit (9). The removable memory card (3) contains a NFC communication element (7). The system can also encompass a separate carrier (13) for PIN entering. The carrier (13) is energetically supplied from the field of the received electromagnetic field. During the payment's authorization, the managing unit (4) in the mobile communication device (1) activates a corresponding secure element (2) with the chosen payment card unit (9) on the removable memory card (3). The mobile communication device (1) communicates with the POS terminal (6) through contactless transmission channel (5).

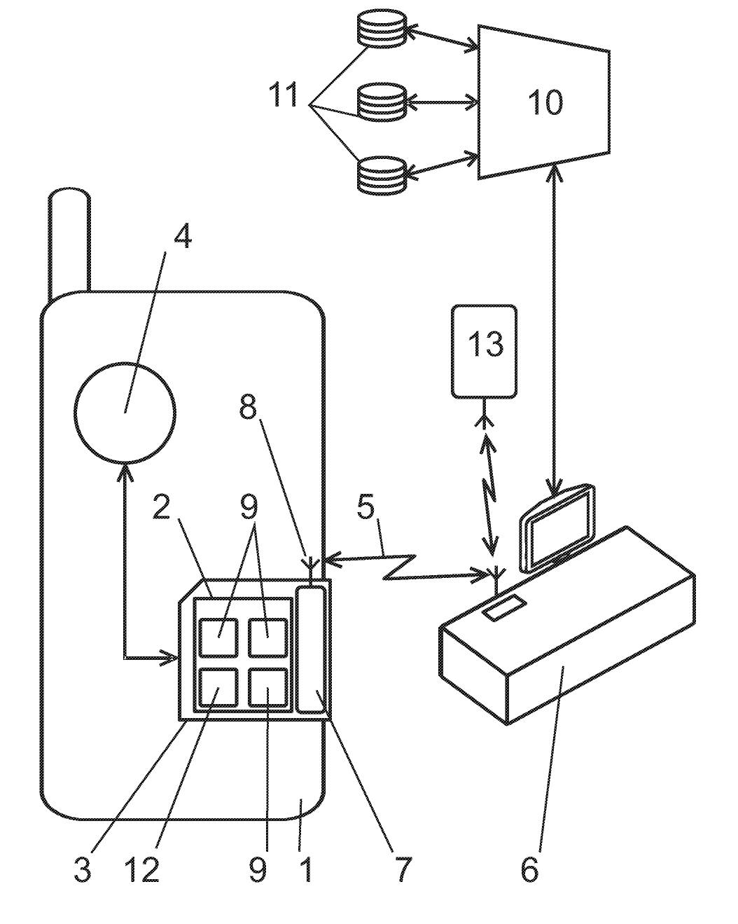

### FIELD OF THE INVENTION

The invention refers to the contactless electronic payment application system, such as are the payments realized through a mobile phone over a POS terminal. The invention also describes the way the payment is confirmed through a mobile communication device that communicates with the POS terminal in a contactless way.

### BACKGROUND OF THE INVENTION

Various payment instruments are known both from experience and from patent files. Through these instruments, the contactless payment over POS terminal is authorized.

The invention as in CN1450782 patent file describes a cooperation between a mobile phone and a POS terminal, however it does not deal with specific hardware implementation that would ensure the required security of payment applications. There also exist such implementations as in CN101136123, according to which the mobile phone can be used for password entering; however the phone's keyboard is not acceptable for the PIN entering from the security point of view.

The solution as in US2002/0147658 A1 describes some relations between the members of the electronic payment process; however it does not deal with the technical organization of individual elements. Other similar inventions as in WO 03/012717 A1 and US2007/0106564 A1 propose the way of organizing the elements, but they do not deal with specific technical implementation that would ensure the courses of payment operations to be secure enough. The invention as in WO 2008/105703 describes the participation of a mobile phone in the communication with a POS terminal; however it does not deal with the storage of payment card data in the mobile phone that would be secure enough. Some possibilities of communication between the POS terminal and the mobile phone are also described in other patent files such as IE 980562, U.S. Pat. No. 6,450,407 B1 and GB 2432031A. These, however, do not offer a configuration that could be comfortably used for securing the payment application.

The existing instruments do not enable to cumulate functions belonging to several independent payment cards in a secure way. However, when the claims of the users are considered, it is required that the manipulation with the payment instrument is simple and quick. It is suitable if a commonly available instrument, such as the mobile phone is today, may be used for payments.

### SUMMARY OF THE INVENTION

The deficiencies mentioned are to a large extent eliminated by the contactless payment application system that consists of the POS terminal which is connected to the payment processor server and which also encompasses a secure element. The system further consists of a mobile communication device with a display and a keyboard, such as a mobile phone. The subject matter of which is based on the fact that the mobile communication device is equipped with a removable card with a memory, in which at least two physically separate secure elements that are connected to a management unit, are located. The mobile communication device is connected to the POS terminal through a contactless transmission link and at least one secure element on the removable memory card contains a payment card unit.

The placement of the secure elements onto the removable memory card creates a precondition that would enable to extend the possibilities of existing phones which have a slot for insertion of the memory card. The important characteristic of the configuration described here is the hardware, physical separation of the secure elements; a solution which enables to store data of payment cards that belong to various financial institutions in a reliable, secure way. The secure elements are connected to a managing unit that activates the secure element. The managing unit always activates the secure element with a chosen payment card data. In the implementation mentioned, a removable memory card can encompass various payment card's functions and according to the number of secure elements, it can even contain a secure area into which personal data or similar can be stored.

In order to ease the entering of a PIN that corresponds to a payment card within the corresponding secure element, it is suitable if the system encompasses a separate carrier for the PIN entering. The carrier contains a PIN storage unit, a PIN encryption unit and also a contactless communication unit; all of which enable the connection of the carrier with the POS terminal and/or with a mobile communication device. The structure within the carrier enables a secure transmission of the encrypted PIN into the POS terminal—directly or over the mobile communication device. In order to reach an easy manipulation with the carrier, it is suitable, if the carrier is passive, without its own long term source of energy and is supplied with energy from the field of the received electromagnetic field.

It would be suitable for the removable memory card to be equipped with a NFC communication element that would enable the connection of the mobile communication device with the POS terminal. In this solution, it is possible to use a mobile communication device, that does not have the NFC communication element incorporated, but that obtains it after the removable memory card is inserted. In order for the manipulation with For easy manipulation with the memory card, when inserting it into the mobile communication's slot, it is suitable if the memory card along with the NFC communication element contains also the antenna for communication with the POS terminal.

In order to reach higher security while entering the PIN over the mobile communication device's keyboard, it is suitable, if there is a one-time password creation unit in the secure element on the removable memory card. The one-time password is created for the given payment process only.

In order to ease the manipulation, the mobile communication device can be equipped with a launch key for contactless payment application. This key carries a payment symbol, for instance in the form of local currency sign. When this key is pressed it automatically launches the payment application and/or it confirms individual steps of the processes.

In preferable configuration, the mobile communication device along with having secure elements on the removable memory card can also have a secure element that is located on the printed circuit board hardware of the mobile communication device. In this secure element, or in the multiple secure elements on the printed circuit board there can be a virtual POS terminal's secured part containing the encryption unit and preferably also the temporary data storage unit. This configuration enables to use the mobile communication device itself as a POS terminal.

The POS terminal is connected to a remote data processing server and the one is connected to at least one database of some financial institution.

The basic frequency of the NFC communication element is 13.56 MHz. In case we want to reach a better penetration of the electromagnetic field within the removable card slot that is shaded, it is appropriate to use a different frequency. While retaining the existing hardware configuration of the POS terminals, this goal can be reach by placing a frequency convertor next to the POS terminal's antenna. The convertor is supplied with energy from the electromagnetic field of the antenna. The antenna on the removable memory card is then set to newly tuned frequencies.

The deficiencies in existing technologies are to a large extent eliminated by a payment authorization method that is used in the contactless payments realized through a POS terminal and a mobile communication device, such as mobile phone, as it is described by this invention. The subject matter of this invention lies in the fact that the managing unit in the mobile communication device uses a managing unit to activate the corresponding secure element with the chosen payment card unit on the removable memory card. The mobile communication device communicates with the POS terminal through contactless transmission connection. This part of the process substitutes the process of the payment card being loaded within the POS terminal's reader.

In case the Card risk management of the chosen payment card banking institution requires the PIN to be entered, it can be realized in several ways. The user can enter PIN using the POS terminal keyboard. A configuration in witch the PIN is stored on a separate PIN carrier enables a comfortable and secure PIN entering by only approaching the carrier to the POS terminal's communication element. For the PIN entering, the POS terminal generates a public key and sends it to the carrier where it is used to encrypt the PIN. Then the PIN is sent to the POS terminal; the transmission channel between the POS terminal and the carrier is contactless. The received encrypted PIN is decrypted by a private key in the POS terminal and it is further processed as if entered over the POS terminal's keyboard.

It is also possible to use a procedure in which a one-time password is created in the one-time password creation unit and then it is sent to the POS terminal.

When the usage possibility of the existing mobile communication devices without their own NFC communication function is considered, it is suitable, if the mobile communication device communicated with the POS terminal through a NFC element incorporated into the removable memory card.

### BRIEF DESCRIPTION OF THE DRAWINGS

The invention is described in more detail on the picture 1, where a contactless payment application system with separate PIN carrier is illustrated. The system also has three payment card units that belong to three different financial institutions, and that are stored on the removable memory card.

### REALIZATION EXAMPLES

### Example 1

The system contains a mobile communication device 1, in the form of a mobile phone without its own NFC communication element. In the mobile communication devices' slot 1 there is a removable memory card 3 of the micros SD format inserted.

On the removable memory card 3 with standard parameters, there are four secure elements 2. Each of them is physically, hardwarely separate and independent. On the removable memory card 3 there is also a managing unit used to switch the respective secure element 2 into an active mode. The managing unit is responsible for an exclusive activity of one secure element. In one removable card's secure element 2 there is a one-time password creation unit 12 and on the other three secure elements there are the payment card units, in this example belonging to three different providers of contactless payment procession such as VISA, EC/MC, and LGM. The removable memory card 3 is connected through its contacts to a printed circuit board of the mobile communication device 1 and through conductive paths of the mobile communication device's 1 hardware it is connected to the managing unit 4. The mobile communication device 1 is connected to the POS terminal 6 through the contactless transmission channel 5 of the NFC type. The mobile communication device 1 communicates with the POS terminal 6 through the NFC communication element 7 that is stored on the removable memory card 3.

The removable memory card 3 is equipped with the NFC communication element 7 including the NFC antenna 8. The system encompasses a separate carrier 13 for PIN entering. This carrier contains a PIN storage unit, a PIN encryption unit and a contactless communication unit that connects the carrier 13 to the POS terminal 6 and/or to a mobile communication device 1. The carrier 13 is in the form of a pendant that transmits the PIN securely into the POS terminal by approaching it to the POS terminal 6. The carrier 13 is energetically supplied from the field of received electromagnetic field and does not have its own energy source in the form of a battery.

The mobile communication device 1 is equipped with a purpose key for the launch of contactless payments application and on the key there is a EURO currency symbol.

The payment procession server 10 is implemented and functions in the same way as is used in the existing payment process with the POS terminals. The payment procession server 10 is also connected to databases 11 of financial institutions, such as banks, which subtract the payments that were effectuated and associated with a specific client from the respective client's account. A sticker containing a frequency convertor is attached to the antenna 8 of the POS terminal 6. The frequency convertor is supplied with energy from the electromagnetic fields of the antenna 8. The antenna 8 on the removable memory card 3 is tuned to the converted frequency.

The payment through a mobile communication device 1 in a store with a POS terminal 6 proceeds in the following way. In the menu, the user selects the type of the card, which he wants to use to realize the payment (VISA, EC/MC, LGM) and then he approaches the mobile communication device 1 to a contactless NFC communication element on the POS terminal 6. The POS terminal 6 identifies the application selected by the user (VISA, EC/MC, and LGM) and sends a request for payment authorization to the payment procession 10 server. The request is processed—first it is verified over the encryption module; it checks whether the application is genuine, and then it generates the request for the financial institution's 11 database. There the request is processed in the same way as if the payment was realized by a real card.

The payment application internally proceeds in such a way that, the managing unit 4 in the mobile communication device activates the corresponding secure element 2 with the chosen payment card unit 9 on the removable memory card 3. The mobile communication device 1 communicates with the POS terminal 6 through the contactless transmission channel 5. In the solution described, the PIN can be entered through the POS terminal 6 keyboard. It is more comfortable to use a separate PIN carrier 13, which is approached to the POS terminal 6 by the user. The POS terminal 6 generates a public key, sends it into the carrier 13, where it is used to encrypt the PIN and subsequently the PIN is sent to the POS terminal 6. The transmission channel between the POS terminal 6 and the carrier 13 is contactless. The received encrypted PIN is decrypted in the POS terminal using the private key.

### Example 2

The system for contactless payment applications that is described in this example is different from the example 1, in the fact that the mobile communication device 1 has its own multiple secure elements 2 on the printed board circuit of the hardware. In this secure element 2 there is the secured part of the virtual POS terminal that contains the encryption unit and preferably even the data temporary storage unit. This configuration enables to use the mobile communication device 1 as a personal virtual POS terminal. The removable memory card 3 is an element that carries the payment card unit 9 and it also extends the mobile communication device 1 for the NFC transmission function.

### INDUSTRIAL APPLICABILITY

The industrial usability is obvious. According to this invention, it is possible to manufacture and use the system for contactless payments, in which the user uses mobile communication device as a payment instrument.

### LIST OF RELATED SYMBOLS

1—a mobile communication device
2—a secure element
3—a removable memory card
4—a managing unit
5—a transmission channel
6—a POS terminal
7—a NFC communication element
8—an antenna
9—a payment card unit
10—a payment procession server
11—a database belonging to a financial institution
12—a one-time password creation unit
13—a PIN carrier

1-13. (canceled)

14. An electronic payment applications system, comprising:
a point-of-sale (POS) terminal connected to a payment processing server; and
a mobile communication device comprising
a removable memory card on which there are located at least two physically separate secure elements, each of the secure elements having a respective payment card unit associated with a respective method of payment, and
a virtual POS managing unit configured to exclusively activate a one of the secure elements having a payment card unit that corresponds to a chosen method of payment,
wherein the mobile communication device is connectable via a contactless communication channel to the POS terminal for authorization of a payment.

15. The electronic payment applications system of claim 14, further comprising a separate carrier via which a personal identification number (PIN) may be entered, wherein the carrier includes a PIN storage block, a PIN encryption block, and a contactless communication block for connecting the carrier with the POS terminal and/or the mobile communication device.

16. The electronic payment applications system of claim 15, wherein the carrier is supplied with energy from a received electromagnetic field.

17. The electronic payment applications system of claim 14, wherein the removable memory card includes a near-field communication (NFC) element and an antenna adapted to connect the mobile communication device to the POS terminal.

18. The electronic payment applications system of claim 14, wherein the removable memory card is equipped with a managing unit that is adapted to switch at least one of the secure elements into an active mode.

19. The electronic payment applications system of claim 14, wherein at least one of the secure elements includes a one-time password creation block.

20. The electronic payment applications system of claim 14, wherein the mobile communication device is equipped with a purpose key to run a direct debit application, and wherein the key carries a payment symbol on it.

21. The electronic payment applications system of claim 14, wherein at least one of the secure elements includes a secured part of the virtual POS terminal, which includes an encryption block and a temporary data storage block.

22. The electronic payment applications system of claim 14, wherein the POS terminal is connected to a remote data processing server, and wherein the remote data processing server is connected to at least one database belonging to a financial institution.

23. The electronic payment applications system of claim 14, wherein the POS terminal comprises an antenna having located thereon a frequency convertor that is supplied with energy from an electromagnetic field of the antenna.

24. A payment authorization method during contactless payment operation while using a point-of-sale (POS) terminal and a mobile communication device, the method comprising:
activating, via a managing block in the mobile communication device, a corresponding secure element with a selected payment card block on a removable memory card; and
establishing a communication between the mobile communication device and the POS terminal through the contactless transmission channel.

25. The payment authorization method of claim 24, further comprising enabling a user to enter a personal identification number (PIN) via a keyboard of the POS terminal.

26. The payment authorization method of claim 25, wherein, in order for the PIN to be entered, the POS terminal generates a public key and sends it to a carrier, the key is used in the carrier to encrypt the PIN, the carrier sends the encrypted PIN to the POS terminal, and the encrypted PIN is decrypted in the POS terminal using a private key that corresponds to the public key, and
wherein communication between the POS terminal and the carrier (13) is via a contactless communication channel.

27. The payment authorization method of claim 24, further comprising creating a password in a one-time password creation block in the mobile communication device, and sending the password to the POS terminal.

28. The payment authorization method of claim 24, wherein the mobile communication device communicates with the POS terminal through a near-field communication element that is located on a removable memory card.

29. A mobile communication device, comprising:
a removable memory card on which there are located at least two physically separate secure elements, each of the secure elements having a respective payment card unit associated with a respective method of payment, and
a virtual POS managing unit configured to exclusively activate a one of the secure elements having a payment card unit that corresponds to a chosen method of payment,
wherein the mobile communication device is connectable via a contactless communication channel to a point of sale (POS) terminal for authorization of a payment.

30. The mobile communication device of claim 29, wherein the removable memory card includes a near-field communication (NFC) element and an antenna adapted to connect the mobile communication device to the POS terminal.

31. The mobile communication device of claim 29, wherein the removable memory card is equipped with a managing unit that is adapted to switch at least one of the secure elements into an active mode.

32. The mobile communication device of claim 29, wherein at least one of the secure elements includes a one-time password creation block, and at least one of the secure elements includes a secured part of the virtual POS terminal, which includes an encryption block and a temporary data storage block.

33. The electronic payment applications system of claim 29, wherein the mobile communication device is equipped with a purpose key to run a direct debit application, and wherein the key carries a payment symbol on it.
